(19) United States
(12) Patent Application Publication
(10) Pub. No.: US 2024/0297410 A1
(43) Pub. Date: Sep. 5, 2024

(54) ELECTRIFIED VEHICLE WITH BATTERY PACK HAVING SEPARATOR WITH APERTURE ARRANGEMENT

(71) Applicant: Ford Global Technologies, LLC, Dearborn, MI (US)

(72) Inventor: Xiaogang Zhang, Novi, MI (US)

(21) Appl. No.: 18/115,870

(22) Filed: Mar. 1, 2023

(51) Int. Cl. H01M 50/491; H01M 10/658; H01M 50/431; H01M 50/457

(52) U.S. Cl. CPC H01M 50/491; H01M 10/658; H01M 50/431; H01M 50/457; H01M 2220/20

(57) ABSTRACT

This disclosure relates generally to battery packs for electrified vehicles, and in particular relates to a separator for a battery pack. The separator includes one or more apertures. The battery pack may include a battery array including a first battery cell spaced-apart from a second battery cell by a separator, wherein the separator includes a layer of thermally insulative material, wherein the layer includes an aperture extending through an entirety of the layer relative to a thickness dimension of the layer.

### TECHNICAL FIELD

This disclosure relates generally to battery packs for electrified vehicles, and in particular relates to a separator for a battery pack. The separator includes one or more apertures.

### BACKGROUND

The need to reduce automotive fuel consumption and emissions is well known. Therefore, vehicles are being developed that reduce or completely eliminate reliance on internal combustion engines. Electrified vehicles are one type of vehicle being developed for this purpose. In general, electrified vehicles differ from conventional motor vehicles because they are selectively driven by battery powered electric machines. Conventional motor vehicles, by contrast, rely exclusively on an internal combustion engine to propel the vehicle.

A high voltage battery pack typically powers the electric machines and other electrical loads of the electrified vehicle. The battery pack includes a plurality of battery cells and various other battery internal components that support electric propulsion of electrified vehicles.

The battery cells generate heat during charging and discharging operations. This heat must be dissipated in order to achieve a desired level of battery performance. Heat exchanger plates, sometimes referred to as thermal exchange plates or “cold plates,” are often employed to dissipate the heat generated by the battery cells. Battery packs are known to include other structures, such as separators, configured to dissipate heat.

### SUMMARY

In some aspects, the techniques described herein relate to a battery pack, including: a battery array including a first battery cell spaced-apart from a second battery cell by a separator, wherein the separator includes a layer of thermally insulative material, wherein the layer includes an aperture extending through an entirety of the layer relative to a thickness dimension of the layer.

In some aspects, the techniques described herein relate to a battery pack, wherein the aperture is one of a plurality of apertures extending through the entirety of the layer relative to the thickness dimension of the layer.

In some aspects, the techniques described herein relate to a battery pack, wherein: the plurality of apertures includes a first set of apertures and a second set of apertures, and the first set of apertures are larger than the second set of apertures.

In some aspects, the techniques described herein relate to a battery pack, wherein the second set of apertures are perforations.

In some aspects, the techniques described herein relate to a battery pack, wherein a total area of the first set of apertures is equal to about 50% of an area defined by an outer perimeter of the layer.

In some aspects, the techniques described herein relate to a battery pack, wherein: the layer includes a plurality of rows, each row includes a plurality of sections of thermally insulative material spaced-apart by a respective one of the apertures of the first set of apertures, and each row includes a staggered arrangement of sections of thermally insulative material and apertures of the first set of apertures relative to adjacent rows.

In some aspects, the techniques described herein relate to a battery pack, wherein a total area of the first set of apertures is equal to about 80% of an area defined by an outer perimeter of the layer.

In some aspects, the techniques described herein relate to a battery pack, wherein: the layer includes a frame providing an outer perimeter of the layer, the frame is made of thermally insulative material, and the first set of apertures are arranged within the frame.

In some aspects, the techniques described herein relate to a battery pack, wherein: the first set of apertures includes four apertures spaced-apart by an internal border, the internal border is made of thermally insulative material, and the internal border is connected to the outer perimeter.

In some aspects, the techniques described herein relate to a battery pack, wherein: the layer is a first layer of the separator, the separator further includes a second layer made of a thermally insulative material spaced-apart from the first layer, and the second layer includes an aperture extending through an entirety of the second layer relative to a thickness dimension of the second layer.

In some aspects, the techniques described herein relate to a battery pack, wherein: the separator further includes a third layer of material outward of the first layer and configured to contact a first battery cell, a fourth layer of material outward of the second layer and configured to contact a second battery cell, and a fifth layer of material between the first and second layers, and the third, fourth, and fifth layers of material are made of a metallic material.

In some aspects, the techniques described herein relate to a battery pack, wherein the third, fourth, and fifth layers of material are made of steel.

In some aspects, the techniques described herein relate to a battery pack, wherein layer is made of a non-metallic material.

In some aspects, the techniques described herein relate to a battery pack, wherein the layer is made of aerogel.

In some aspects, the techniques described herein relate to a battery pack, wherein the battery pack is configured such that a compressive force applied along a length of the array holds the separator in place relative to the first battery cell and the second battery cell.

In some aspects, the techniques described herein relate to a battery pack, wherein the battery pack is a battery pack of an electrified vehicle.

In some aspects, the techniques described herein relate to a separator for a battery pack, including: a layer of thermally insulative material, wherein the layer includes an aperture extending through an entirety of the layer relative to a thickness dimension of the layer.

In some aspects, the techniques described herein relate to a separator, wherein: the aperture is one of a plurality of apertures extending through the entirety of the layer relative to the thickness dimension of the layer, and a total area of the plurality of apertures is equal to about 50% or 80% of an area defined by an outer perimeter of the layer.

In some aspects, the techniques described herein relate to a method, including: thermally insulating a first battery cell of a battery pack from a second battery cell of the battery pack by providing a separator between the first battery cell and the second battery cell, wherein the separator includes a layer of thermally insulative material, and wherein the separator includes an aperture extending through an entirety of the layer relative to a thickness dimension of the layer.

In some aspects, the techniques described herein relate to a method, wherein: the aperture is one of a plurality of apertures extending through the entirety of the layer relative to the thickness dimension of the layer, and a total area of the plurality of apertures is equal to about 50% or 80% of an area defined by an outer perimeter of the layer.

### BRIEF DESCRIPTION OF THE DRAWINGS

FIG. 1 schematically illustrates an example powertrain of an electrified vehicle.

FIG. 2 is a perspective, exploded-view of a portion of an example battery pack.

FIG. 3 is a side view of a portion of the battery pack.

FIG. 4 is a perspective, exploded-view of a first example separator.

FIG. 5 is a perspective view of the first example separator in an assembled state.

FIG. 6 is a perspective, exploded-view of a second example separator.

FIG. 7 is a perspective view of the second example separator in an assembled state.

### DETAILED DESCRIPTION

This disclosure relates generally to battery packs for electrified vehicles, and in particular relates to a separator for a battery pack. The separator includes one or more apertures. Among other benefits, which will be appreciated from the below description, this disclosure reduces heat transferred between adjacent battery cells, without requiring additional material or space relative to known designs.

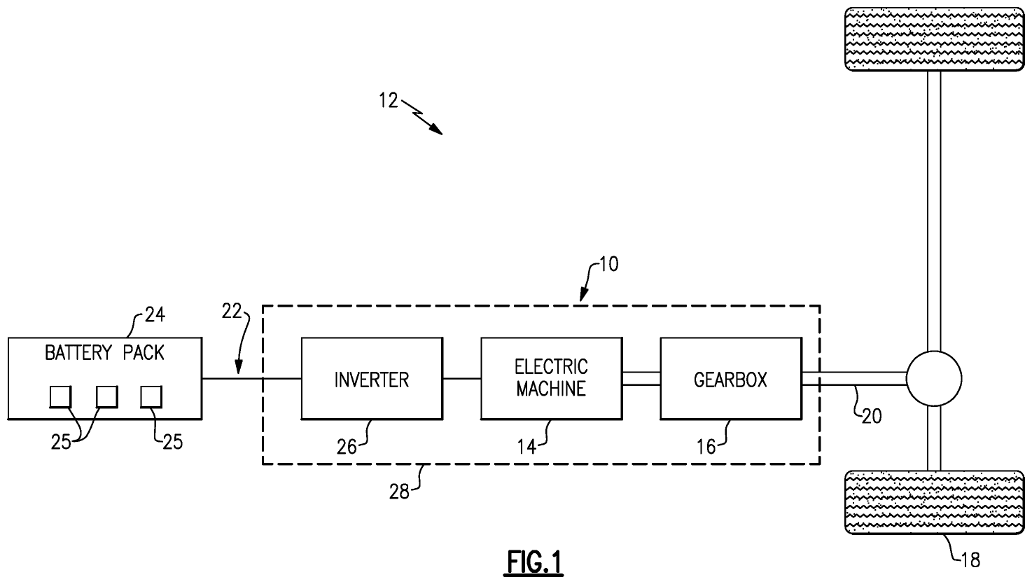

FIG. 1 schematically illustrates a powertrain 10 of an electrified vehicle 12. Although depicted as a battery electric vehicle (BEV), it should be understood that the concepts described herein are not limited to BEVs and could extend to other electrified vehicles, including but not limited to, plug-in hybrid electric vehicles (PHEVs). Therefore, although not shown in this embodiment, the electrified vehicle 12 could be equipped with an internal combustion engine that can be employed in combination with other energy sources to propel the electrified vehicle 12.

In a non-limiting embodiment, the electrified vehicle 12 is a full electric vehicle propelled solely through electric power, such as by an electric machine 14, without any assistance from an internal combustion engine. The electric machine 14 may operate as an electric motor, an electric generator, or both. The electric machine 14 receives electrical power and provides a rotational output power. The electric machine 14 may be connected to a gearbox 16 for adjusting the output torque and speed of the electric machine 14 by a predetermined gear ratio. The gearbox 16 is connected to a set of drive wheels 18 by an output shaft 20. A high voltage bus 22 electrically connects the electric machine 14 to a battery pack 24 through an inverter 26. The electric machine 14, the gearbox 16, and the inverter 26 may collectively be referred to as a transmission 28.

The battery pack 24 is an exemplary electrified vehicle battery. The battery pack 24 may be a high voltage traction battery pack that includes a plurality of battery assemblies 25 (i.e., battery arrays or groupings of battery cells) capable of outputting electrical power to operate the electric machine 14 and/or other electrical loads of the electrified vehicle 12. Other types of energy storage devices and/or output devices can also be used to electrically power the electrified vehicle 12.

The powertrain 10 shown in FIG. 1 is highly schematic and is not intended to limit this disclosure. Various additional components could alternatively or additionally be employed by the powertrain 10 within the scope of this disclosure.

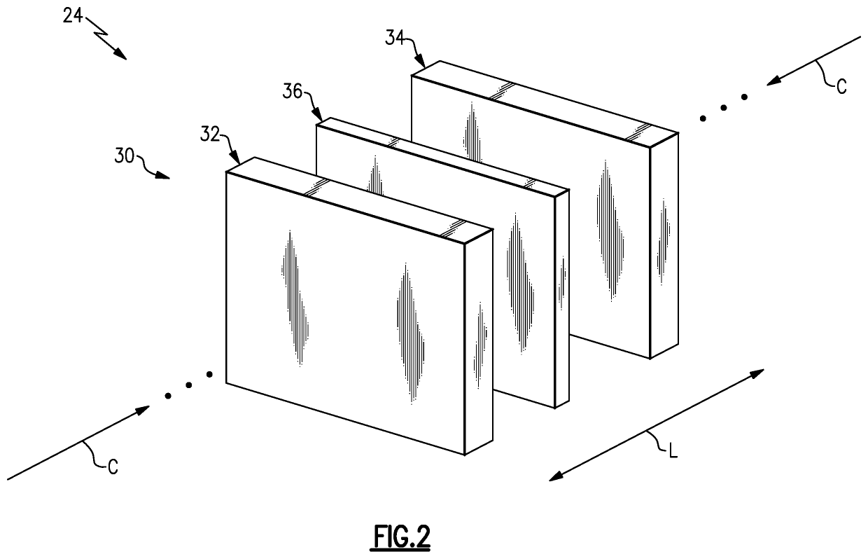

FIG. 2 illustrates some components of an example battery pack 24. Specifically, FIG. 2 illustrates a portion of a battery array 30, which includes a plurality of battery cells arranged along a length L of the battery array 30. The battery array 30 is enclosed by an enclosure assembly. The battery pack 24, through the enclosure assembly or otherwise, is configured to apply a compressive force C along the length of the battery array 30 to hold the components of the battery pack 24, namely the battery cells and other structures, such as separators, in place.

FIG. 2 illustrates two of the plurality of battery cells within the battery array 30. Specifically, FIG. 2 illustrates a first battery cell 32 and a second battery cell 34. The battery array 30 further includes a separator 36 between the first battery cell 32 and the second battery cell 34. The separator 36 may be referred to as a thermal separator and is configured to reduce heat transfer between the first battery cell 32 and the second battery cell 34.

In an embodiment, battery cells 32, 34 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

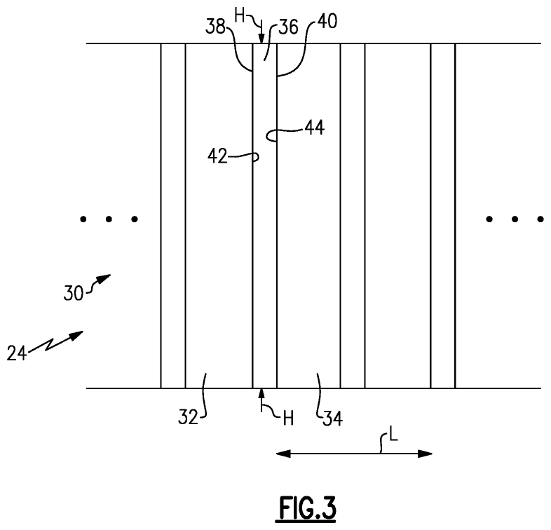

In FIG. 2, the first battery cell 32, second battery cell 34, and separator 36 are shown spaced-apart from one another along the length L of the battery array 30. When the battery array 30 is assembled, however, the battery pack 24 is configured to apply a compressive force C to the first battery cell 32, second battery cell 34, and separator 36 such that the first battery cell 32 is in direct contact with the separator 36, and such that the second battery cell 34 is in direct contact with the separator 36, as represented in FIG. 3.

FIG. 3 illustrates a side view of a portion of the battery array 30. As shown, the first battery cell 32, second battery cell 34, and separator 36 are stacked face-to-face along a length L of the battery array 30. In particular, the separator 36 includes a first face 38 and a second face 40 opposite the first face 38. The first face 38 is in direct contact with an adjacent face 42 of the first battery cell 32, and the second face 40 is in direct contact with an adjacent face 44 of the second battery cell 34.

Along the length L of the battery array 30, there is a separator between each battery cell in this example. In other examples, there may be a separator between adjacent groups of battery cells, such as between every two or every four battery cells.

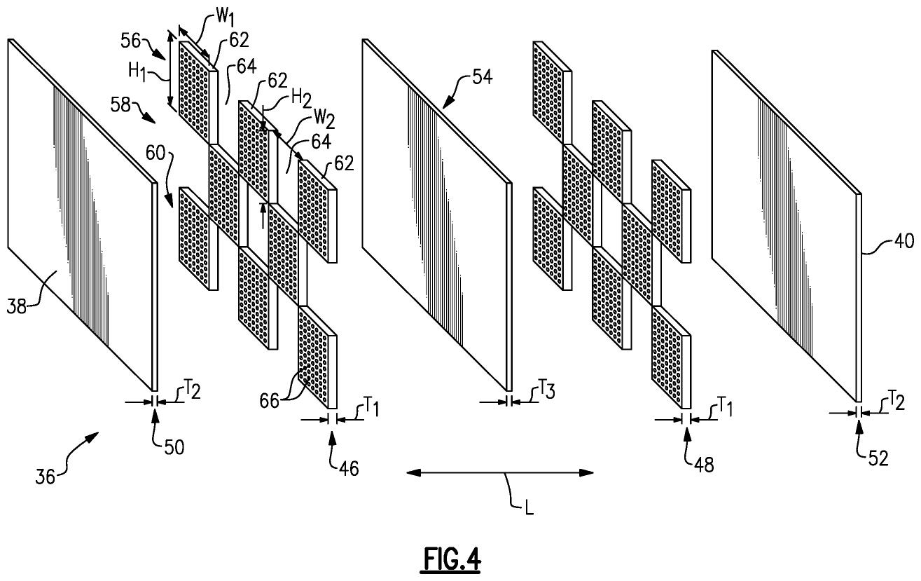

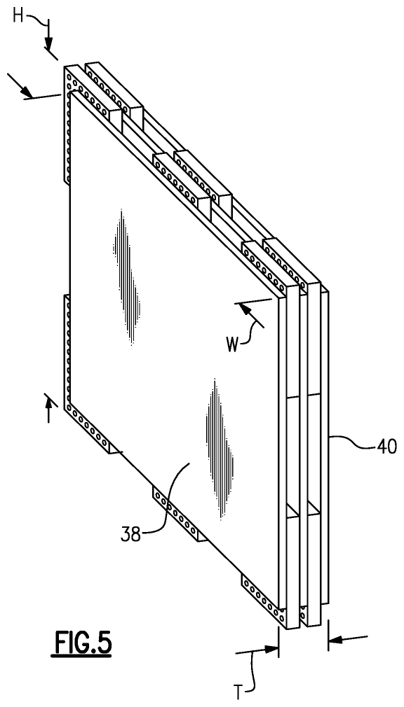

FIGS. 4 and 5 illustrate additional detail of the separator 36 according to a first embodiment of this disclosure. The separator 36 includes a plurality of layers of material. In general, the separator 36 exhibits a height H (best seen in FIG. 3) and a width W. The separator 36 exhibits an overall thickness T, which is substantially 4.4 mm. The term “substantially” as used herein to refer to particular dimensions is intended to encompass a designed dimension and reasonable tolerances. For instance, the thickness T is designed to be 4.4 mm but in practice may vary slightly, within reasonable tolerances.

In this disclosure, the separator 36 includes at least one layer of thermally insulative material with an aperture extending through the entirety of the thickness of the layer, in a direction parallel to the dimension of the thickness T. In this way, the layer includes an air gap and requires relatively less thermally insulative material than in some known designs. As such, the layer provides effective heat insulation while reducing the quantity of material required to form the layer.

In an example, the separator 36 includes five layers, including a first layer of thermally insulative material 46 (each layer may be referred to, for example, using shorthand, such that the first layer of thermally insulative material 46 may be referred to as “first layer 46” or “layer 46”) and a second layer of thermally insulative material 48 spaced-apart from the first layer 46. Both the first and second layers 46, 48 include apertures extending through the entirety of the thickness of each respective layer 46, 48. The apertures discussed herein are either formed using a manufacturing technique, such as stamping, injection molding, or a machining technique, such as drilling, cutting, or laser cutting, as examples. The apertures further reference any openings within the outer perimeter of the layers 46, 48. In this regard, an aperture can be present adjacent an outer perimeter of the layer, despite an aperture in such a location not being bound by thermally insulative material on at least one side.

The separator 36 further includes a third layer of material 50 outward of the first layer 46. The third layer of material 50 provides the first face 38 and is configured to contact a first battery cell 32. The separator 36 also includes a fourth layer of material 52 outward of the second layer 48 and providing the second face 40 such that the fourth layer 52 is configured to directly contact the second battery cell 34. Finally, the separator 36 includes a fifth layer of material 54 between the first and second layers 46, 48.

Each of the layers 46, 48, 50, 52, 54 exhibits a common height and width in this example, which is substantially equal to the height H and width W of the separator 36. The height H and width of the separator 36 may be slightly greater than the corresponding height and width dimensions of the battery cells 32, 34.

The first and second layers 46, 48 are made of a non-metallic material, in this example. In particular, the first and second layers 46, 48 are made of aerogel. The third, fourth, and fifth layers 50, 52, 54 are made of a metallic material, such as steel.

A first example aperture arrangement for the layers 46, 48 will now be described with reference to layer 46. It should be understood that layer 48 is configured substantially similarly.

Layer 46 includes a plurality of apertures. Specifically, layer 46 includes a first set of apertures and a second set of apertures. The first set of apertures may be of a different size and/or type than the second set of apertures. In particular, the first set of apertures are larger than the second set of apertures in one example.

Here, the first set of apertures are provided by the arrangement of the layer 46 into staggered rows. Specifically, layer 46 includes a plurality of rows 56, 58, 60. With respect to row 56, which is a top-most row, the row 56 includes a plurality of sections 62 of thermally insulative material spaced-apart by a respective one of the apertures 64 of the first set of apertures. The sections 62 exhibit an area defined by height H₁ and width W₁, and the apertures 64 exhibit an area defined by height H₂ and width W₂. The sections 62 and apertures 64 exhibit a substantially equal area, and in particular the heights H₁, H₂ are substantially equal, and the widths W₁, W₂ are substantially equal. Row 58 is configured substantially similarly to row 56, but the sections 62 and apertures 64 are staggered relative to the rows 56, 60, such that the sections 62 are vertically (i.e., in the direction of height H) adjacent to an aperture 64 of an adjacent row, and apertures 64 are vertically adjacent to a section 62 of an adjacent row.

The layer 46 is arranged such a total area of the first set of apertures 64 is equal to about 50% of an area defined by an outer perimeter of the layer 46. As such, a plurality of air gaps are formed and the material required to produce the layer 46 is reduced. In turn, the layer 46 is able to efficiently reduce heat transfer.

In addition to the first set of apertures, the layer 46 includes a second set of apertures 66. The second set of apertures 66 are each considerably smaller than the first set of apertures. The second set of apertures 66 are perforations, in this example.

The layer 46 may be provided with the first set of apertures 64 using a manufacturing process such as stamping or cutting. The material removed to form the first set of apertures 64 could be used to form the sections of thermally insulative material of another layer. The second set of apertures 66 could be formed using another process, such as drilling, laser cutting, etc.

In this example, the layers 46, 48 exhibit a common thickness T₁, which is substantially 2 mm. The third and fourth layers 50, 52 a common thickness T₂ different than the thickness T₁. Here, thickness T₂ is substantially 0.1 mm. The fifth layer 54 exhibits a third thickness T₃ of substantially 0.2 mm. Again, the overall thickness T is substantially 4.4 mm. The arrangement of layers 46, 48, 50, 52, 54, and their respective thicknesses, provides the separator 36 with an overall thickness T substantially equal to the thickness of known separators, such that the design of the battery array 30 does not need to change to accommodate the separator 36. Further, relative to some known designs, the separator 36 uses less thermally insulative material while providing substantially the same insulation. The arrangement of the layers 50, 52, 54 evenly distributes compressive forces applied to the battery array 30, which in turn holds the layers 46, 48 in place.

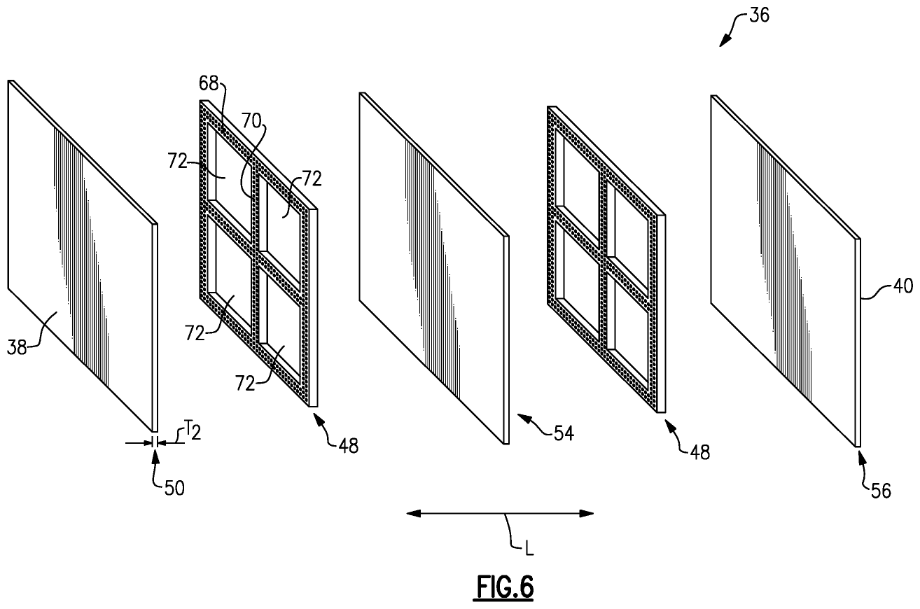

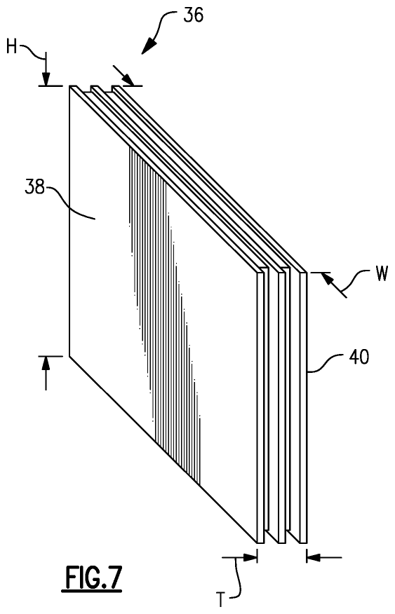

FIGS. 6 and 7 illustrate additional detail of the separator 36 according to a second embodiment of this disclosure. The second embodiment is substantially similar to the first embodiment with the exception of the arrangement of the first set of apertures of the layers 46, 48, which will now be described relative to layer 46.

In FIGS. 6 and 7, layer 46 includes a frame 68 extending about, and providing, an entire outer perimeter of the layer 46. The frame 68 is connected to an internal border 70. The frame and internal border 68, 70 establish four substantially equally sized apertures 72, which are spaced-apart from one another by the internal border 70, and which together provide the first set of apertures 72 of the layer 46. Together, a total area of the first set of apertures 72 is equal to about 80% of an area defined by an outer perimeter of the layer 46. The internal border 70 helps to maintain rigidity of the layer 46 but is not required in all examples.

While FIGS. 4-7 show layers thermally insulative material with multiple apertures, this disclosure extends to layers of thermally insulative material with one or more apertures. Further, a separator could include layers of thermally insulative material having different aperture arrangements. For instance, a separator could include a first layer arranged similar to layer 46 in FIG. 4 and a second layer arranged similar to layer 46 in FIG. 6.

Because the layers 50, 52, 54 are thermal conductors, in some embodiments the battery pack 24 may include one or more heat sinks in communication with the layers 50, 52, 54. As an example, one or more thermal exchange plates could be in contact with the layers 50, 52, 54 either directly or via a relatively thin layer of a thermal interface material (TIM).

It should be understood that terms such as “about,” “substantially,” and “generally” are not intended to be boundaryless terms, and should be interpreted consistent with the way one skilled in the art would interpret those terms. It should also be understood that directional terms such as “upper,” “top,” “vertical,” “forward,” “rear,” “side,” “above,” “below,” etc., are used herein relative to the normal operational attitude of a vehicle for purposes of explanation only, and should not be deemed limiting.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A battery pack, comprising:
a battery array including a first battery cell spaced-apart from a second battery cell by a separator, wherein the separator includes a layer of thermally insulative material, wherein the layer includes an aperture extending through an entirety of the layer relative to a thickness dimension of the layer.

2. The battery pack as recited in claim 1, wherein the aperture is one of a plurality of apertures extending through the entirety of the layer relative to the thickness dimension of the layer.

3. The battery pack as recited in claim 2, wherein:
the plurality of apertures includes a first set of apertures and a second set of apertures, and
the first set of apertures are larger than the second set of apertures.

4. The battery pack as recited in claim 3, wherein the second set of apertures are perforations.

5. The battery pack as recited in claim 3, wherein a total area of the first set of apertures is equal to about 50% of an area defined by an outer perimeter of the layer.

6. The battery pack as recited in claim 5, wherein:
the layer includes a plurality of rows,
each row includes a plurality of sections of thermally insulative material spaced-apart by a respective one of the apertures of the first set of apertures, and
each row includes a staggered arrangement of sections of thermally insulative material and apertures of the first set of apertures relative to adjacent rows.

7. The battery pack as recited in claim 3, wherein a total area of the first set of apertures is equal to about 80% of an area defined by an outer perimeter of the layer.

8. The battery pack as recited in claim 7, wherein:
the layer includes a frame providing an outer perimeter of the layer,
the frame is made of thermally insulative material, and
the first set of apertures are arranged within the frame.

9. The battery pack as recited in claim 8, wherein:
the first set of apertures includes four apertures spaced-apart by an internal border,
the internal border is made of thermally insulative material, and
the internal border is connected to the outer perimeter.

10. The battery pack as recited in claim 1, wherein:
the layer is a first layer of the separator,
the separator further comprises a second layer made of a thermally insulative material spaced-apart from the first layer, and
the second layer includes an aperture extending through an entirety of the second layer relative to a thickness dimension of the second layer.

11. The battery pack as recited in claim 10, wherein:
the separator further comprises a third layer of material outward of the first layer and configured to contact a first battery cell, a fourth layer of material outward of the second layer and configured to contact a second battery cell, and a fifth layer of material between the first and second layers, and
the third, fourth, and fifth layers of material are made of a metallic material.

12. The battery pack as recited in claim 11, wherein the third, fourth, and fifth layers of material are made of steel.

13. The battery pack as recited in claim 1, wherein layer is made of a non-metallic material.

14. The battery pack as recited in claim 13, wherein the layer is made of aerogel.

15. The battery pack as recited in claim 1, wherein the battery pack is configured such that a compressive force applied along a length of the array holds the separator in place relative to the first battery cell and the second battery cell.

16. The battery pack as recited in claim 1, wherein the battery pack is a battery pack of an electrified vehicle.

17. A separator for a battery pack, comprising:
a layer of thermally insulative material, wherein the layer includes an aperture extending through an entirety of the layer relative to a thickness dimension of the layer.

18. The separator as recited in claim 17, wherein:
the aperture is one of a plurality of apertures extending through the entirety of the layer relative to the thickness dimension of the layer, and
a total area of the plurality of apertures is equal to about 50% or 80% of an area defined by an outer perimeter of the layer.

19. A method, comprising:
thermally insulating a first battery cell of a battery pack from a second battery cell of the battery pack by providing a separator between the first battery cell and the second battery cell, wherein the separator includes a layer of thermally insulative material, and wherein the separator includes an aperture extending through an entirety of the layer relative to a thickness dimension of the layer.

20. The method as recited in claim 19, wherein:
the aperture is one of a plurality of apertures extending through the entirety of the layer relative to the thickness dimension of the layer, and
a total area of the plurality of apertures is equal to about 50% or 80% of an area defined by an outer perimeter of the layer.
